(19) United States
(12) Patent Application Publication
(10) Pub. No.: US 2012/0230701 A1
(43) Pub. Date: Sep. 13, 2012

(54) OPTICAL SPACE COMMUNICATION DEVICE, COMMUNICATION METHOD THEREOF AND OPTICAL SPACE COMMUNICATION SYSTEM

(76) Inventors: SHIGERU MURATA, Tokyo (JP); SATOAKI ITO, Tokyo (JP); YUKITERU KAKIMOTO, Tokyo (JP)

(21) Appl. No.: 13/368,545

(22) Filed: Feb. 8, 2012

(30) Foreign Application Priority Data
Mar. 7, 2011 (JP) 2011-048441

(51) Int. Cl. H04B 10/02

(52) U.S. Cl. 398/140

(57) ABSTRACT

A optical space communication device, including: a transmission module transmitting an optical signal to a specific opposite communication device whose position is known, a reception module receiving the optical signal transmitted from a plurality of indefinite opposite communication devices, and a central communication control device controlling the transmission module and the reception module.

### INCORPORATION BY REFERENCE

This application is based upon and claims the benefit of priority from Japanese patent applications No. 2011-048441, filed on Mar. 7, 2011, the disclosure of which is incorporated herein its entirety by reference.

### BACKGROUND OF THE INVENTION

1. Field of the Invention

The present invention relates to an optical space communication device, communication method thereof and an optical apace communication system, and in particular, to an optical space communication device, communication method thereof and an optical apace communication system performing an optical apace communication between mobile units.

2. Description of the Related Art

When an optical space communication is performed between a plural of mobile unit, for example, between a plural of fighter which move at a high speed, it would be desirable that a mobile unit can communicate with a plural of opposite mobile unit always. The optical apace communication is characterized in high capacity and highly-confidential communication. Therefore, it is possible to perform a communication difficult for a micro wave communication or a millimeter wave communication to realize. Further, since a spread angle of a transmission beam is narrow in the optical apace communication between mobile units, it is important to control a transmission and a reception beams in accordance with the spread angle.

On the other hand, an example of the optical space communication device related to the present invention is disclosed in the Patent document 1 (the Japanese Patent Publication Laid-Open No. 2009-177654). Disclosed in the document is the optical space communication device transmitting an optical beam toward the opposite optical space communication device in accordance with a direction of an optical beam received from the opposite optical space communication device.

The optical space communication device provides a lens system receiving an optical beam transmitted from the opposite optical space communication device and focusing the optical beam on the focusing screen, a beam splitter dividing an optical beam passed through the lens system into two optical beams, an area sensor provided on the focusing screen on which one optical beam which is divided by the beam splitter focuses and a photo detector on the focusing screen is arranged on it two-dimensionally, a laser array provided on the focusing screen on which the other optical beam divided by the beam splitter focuses and a laser on the laser array is arranged two-dimensionally, and a control mechanism which detects which one of the photo detectors on the area sensor detects the optical beam, and selects the laser on the laser array which provides a arrangement coordinate corresponds to the arrangement coordinate of the photo detector detected the optical beam, as a laser which transmits an optical beam toward the opposite optical space communication device.

Further, another example of the optical space communication device is disclosed in the Patent document 2 (the Japanese Patent Publication Laid-Open No. 2007-109923). The disclosed optical space communication device provides an incident window which inputs light, a light deflection unit deflecting the light input to the incident window, a focus light means focusing the deflected light by the light deflection unit and a photo-detection means detecting light focused by the focus light means.

Further more, another example of the optical space communication device is disclosed in the Patent document 3 (the Japanese Patent Publication Laid-Open No. 08-213954). The disclosed optical space communication device provides in a reception device, three PIN photodiodes of which light-receiving angle is different each other, three amplifier circuits corresponding to each PIN photodiode, three detection circuits corresponding to each amplifier circuit, three switches switching three amplifier circuits and a control unit controlling three detection circuits and three switches. Therefore, the disclosed optical space communication device is possible to receive a plural of optical signal from the different direction each other always.

On the other hand, in the above-mentioned related art. a problem exists that the related optical apace communication device cannot transmit the optical signal to the opposite optical space communication device without synchronizing with a specific opposite optical space communication device, and cannot receive the optical signal from a plurality of indefinite opposite communication devices at the same time.

And another problem exists that, on the occasion of receiving the optical signal, it is difficult to distinguish a plural of optical signals transmitted from the same direction.

Further, another problem exists that, on the occasion of transmitting the optical signal, it is difficult to transmit the signal to an opposite communication device at a long distance because a signal strength becomes low if a spread angle of a transmission beam becomes wide, and on the other hand, although the signal strength becomes high if the spread angle of the transmission beam is narrow, it is difficult to match the direction of the optical beam to the opposite communication device at a short distance.

On the other hand, the invention disclosed in the patent document I regards to, after detecting the direction of the optical reception beam, transmit an optical beam for the opposite communication device to the same direction. Therefore, the optical beam cannot be transmitted to the opposite communication device unless the direction of the optical reception beam can be detected, and so the problem of the present invention cannot be solved by the invention disclosed in the patent document 1.

Also, according to the invention disclosed in the patent document 2, the optical beam cannot be transmitted to the opposite communication device unless the direction of the optical reception beam can be detected. Therefore, the problem of the present invention cannot be solved by the invention disclosed in the patent document 2.

Further more, according to the invention disclosed in the patent document 3, only a part of the function of the present invention which makes it possible to receive a plural of optical signal from the different direction always is disclosed in it. Therefore, the problem of the present invention cannot be solved by the invention disclosed in the patent document 3.

### SUMMARY

An exemplary object of the invention is to provide an optical space communication device, a communication method thereof, an optical space communication system which make it possible to transmit an optical signal to the opposite communication device without synchronizing the communication device of itself with a specific opposite communication device, to receive the optical signal from a plurality of indefinite opposite communication devices at the same time of the transmission, to distinguish a plural of optical signal transmitted from the same direction on the occasion of receiving the optical signal, and to control a spread angle of the transmission beam in accordance with the distance of the opposite communication device.

An exemplary aspect of the invention is an optical space communication device, including:

a transmission module transmitting an optical signal to a specific opposite communication device whose position is known,

a reception module receiving the optical signal transmitted from a plurality of indefinite opposite communication devices, and

a central communication control device controlling the transmission module and the reception module.

Another exemplary aspect of the invention is a communication method of an optical space communication device, wherein the optical space communication device includes:

a transmission module transmitting an optical signal,

a reception module receiving the optical signal, and

a central communication control device controlling the transmission module and the reception module:

wherein the central communication control device performs;

instructing the transmission module to transmit the optical signal to a specific opposite communication device whose position is known, and

instructing the reception module to receive the optical signal transmitted from a plurality of indefinite opposite communication devices.

Another exemplary aspect of the invention is an optical space communication system, including:

a plural of the optical space communication device;

wherein a mesh type network is configured with each optical space communication device.

### BRIEF DESCRIPTION OF THE DRAWINGS

FIG. 1 is an example of a configuration of an optical space communication device according to the present invention;

FIG. 2 is a diagram showing an example of a relief map of an operation of an asynchronous burst communication in case of assuming a mobile unit 1 as a main mobile unit according to the present invention;

FIG. 3 is a flow chart showing an example of a communication method of a mobile unit according to the present invention;

FIG. 4 is a diagram showing an example of a configuration of an optical space communication device according to the present invention;

FIG. 5 is a diagram showing an example of a relief map of an arrangement method of transmission and reception modules of a mobile unit according to the present invention;

FIG. 6 is a flow chart showing an example of an operation of a capture and track method of an opposite communication device in an optical space communication device according to the present invention;

FIG. 7 is a diagram showing an example of a configuration of an reception module in an optical space communication device according to the present invention;

FIG. 8 is a diagram showing an example of a configuration of a readout unit (ROIC) 23 according to the present invention;

FIG. 9 is a diagram showing an example of a configuration of a transmission module in an optical space communication device according to the present invention;

FIG. 10 is a flow chart showing an example of an operation of a spread angle control unit 44 according to the present invention;

### EXEMPLARY EMBODIMENTS

Hereinafter, exemplary embodiments of the present invention will be described with referring to the attached drawings.

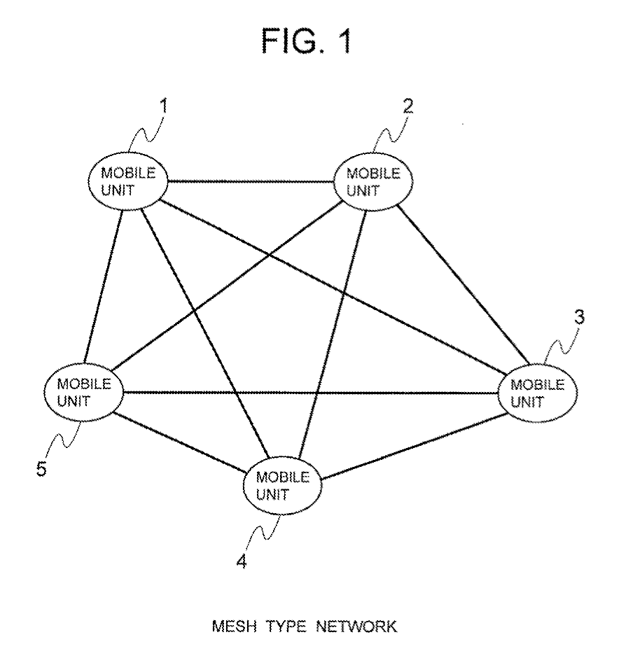

FIG. 1 is a diagram showing an example of a configuration of an optical space communication device according to the present invention. Referring to FIG. 1, an example of the optical space communication system of the present invention provides, for example, five mobile units 1-5. The mobile units 1-5 are optical space communication devices. Then each of the mobile units 1-5 is configured to be possible to communicate with each other and also configured to form, what is called, a mesh type network.

Moreover, a number of the mobile units is not limited to 5. The mobile units are possible to be formed with more than 2 units arbitrary.

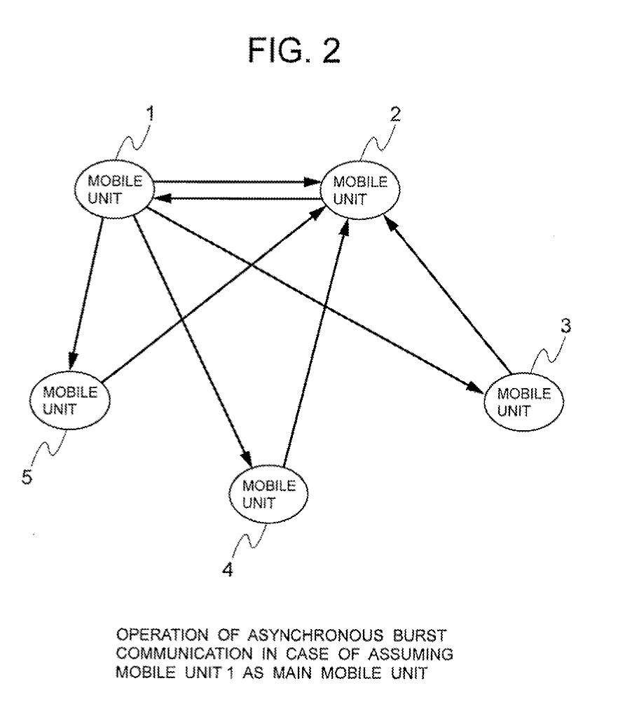

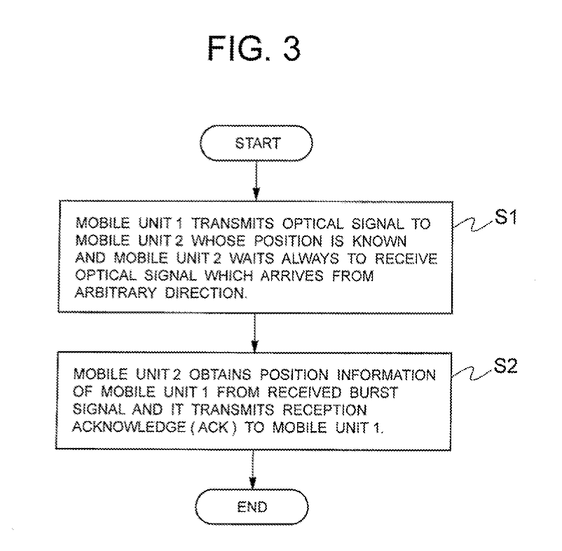

FIG. 2 is a diagram showing an example of a relief map of an operation of an asynchronous burst communication in case of assuming a mobile unit 1 as a main mobile unit according to the present invention. Moreover, it should be noted that elements equal to those in FIG. 1 are assigned with identical numerals and description thereof is omitted. FIG. 3 is a flow chart showing an example of a communication method of a mobile unit according to the present invention.

Hereinafter, an example of a communication method of a mobile unit is described with referring to FIGS. 2 and 3. For example, a communication method in case of assuming a mobile unit 1 as a main mobile unit is described below. Since it is easily realized to get a communication speed of a degree of 1 Gbps, it is possible to transmit a large amount of data such as a degree of 1 MB in an instant in a transmission time of 10 ms which is burst like.

The mobile unit 1 transmits an optical signal to a mobile unit 2 whose position is known. At this time, the mobile unit 1 includes the position information of itself in the optical signal. The mobile unit 1 transmits the optical signal at a free timing without synchronization with the mobile-unit 2. On the other hand, the mobile unit 2 waits always to receive the optical signal which arrives from the arbitrary direction, for example, from an angle of 360 degrees (Step 1 of FIG. 3).

Then when a burst signal is transmitted from the mobile unit 1, the mobile unit 2 obtains the position information of the mobile unit 1 from the received burst signal. The mobile unit 2 detects in an instant that the burst signal was transmitted from the mobile unit 1 from the positioning information. When the mobile unit 2 receives the burst signal, it transmits a reception acknowledge (ACK) to the mobile unit 1 (Step 2 of FIG. 3). Moreover, it is possible to configure the mobile unit 2 not to transmit the reception acknowledge (ACK) to the mobile unit 1 even if it receives this burst signal.

The mobile unit 1 can perform a retransmission to the mobile unit 2 if necessary, whenever it receives no response from the mobile unit 2 or the communication between the mobile units 1 and 2 has a protocol which requires no response. Moreover, the mobile unit 1 can perform an interactive communication always with the mobile unit 2. Moreover, the mobile unit 1 can transmit an optical signal to each of the mobile units 3-5 in order. Moreover, the mobile unit 1 can perform a pseudo broadcast communication with the mobile units 3-5. Further, for example, the mobile unit 1 can receive a signal from the mobile unit 4 at the same time when it transmits an optical signal to the mobile unit 2.

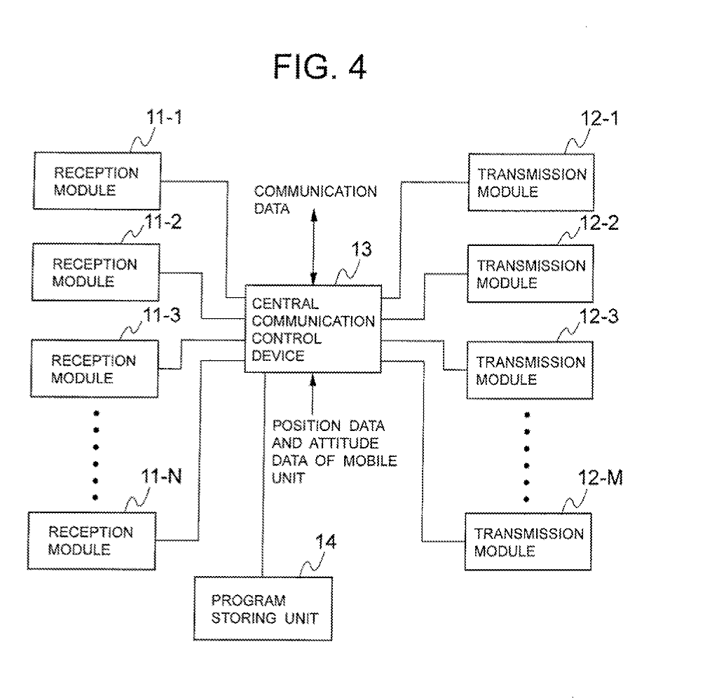

FIG. 4 is a diagram showing an example of a configuration of an optical space communication device according to the present invention. Referring to FIG. 4, an example of the optical space communication device according to the present invention includes N (N is a integer equal to or more than 2) reception modules 11-1 to 11-N, M (M is a integer equal to or more than 2) transmission modules 12-1 to 12-M, a central communication control device 13 and a program storing unit 14.

The reception modules 11-1 to 11-N receive an optical signal. The transmission modules 12-1 to 12-M transmit an optical signal. The central communication control device 13 controls the reception modules 11-1 to 11-N and the transmission modules 12-1 to 12-M.

The central communication control device 13 switches the reception modules 11-1 to 11-N and the transmission modules 12-1 to 12-M, and uses some of them. The central communication control device 13 has a function inputting a communication data from outside or outputting the communication data to outside. Moreover, the central communication control device 13 holds a position data of itself (for example, which is obtained from GPS (Global Positioning System), and so on) and an attitude data of itself (which is obtained from a gyro of itself not shown, and so on). Further, it is also possible to let the central communication control device 13 hold the position data of the other optical space communication devices.

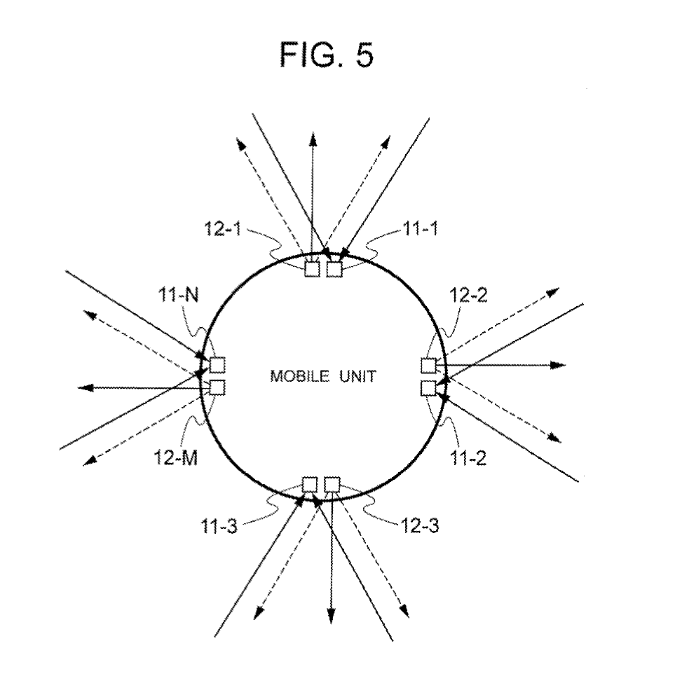

FIG. 5 is a diagram showing an example of a relief map of an arrangement method of transmission and reception modules of a mobile unit according to the present invention. Moreover, it should be noted that elements equal to those in FIG. 4 are assigned with identical numerals and description thereof is omitted. Further, although an example of the configuration of the mobile unit 1 is shown in FIG. 5 for convenience sake, the configuration of the mobile units 2-5 are the same as the mobile unit 1.

Referring to FIG. 5, the mobile unit 1 is formed, for example, spherically. However, the present invention is not limited to the form. It is also possible to form the mobile unit 1 with an arbitrary polyhedron.

The reception module 11-1 and the transmission module 12-1 are arranged side by side on the surface of the mobile unit 1. Moreover, the reception module 11-2 and the transmission module 12-2 are arranged side by side on the different position of the surface of the mobile unit 1 from the position of the reception module 11-1 and the transmission module 12-1. Similarly, the reception module 11-3 and the transmission module 12-3 are arranged side by side on the different position of the surface of the mobile unit 1 from the position of the reception modules 11-1, 11-2 and the transmission modules 12-1, 12-2. Further, the reception module 11-N and the transmission module 12-M are arranged side by side on the different position of the surface of the mobile unit 1 from the position of the reception modules 11-1 to 11-3 and the transmission modules 12-1 to 12-3.

Referring to FIG. 5, the optical signals input to the reception modules 11-1 to 11-N are denoted as arrows of solid lines and the optical signals output from the transmission modules 12-1 to 12-M are denoted as arrows of broken lines and solid lines. That is, the reception modules 11-1 to 11-N receive the optical signal input from the respective direction always and the transmission modules 12-1 to 12-M transmit the optical signal to the specified direction (to the direction denoted as arrows of solid lines). However, it is possible to change the direction of the transmission signal to the other directions (to the direction denoted as broken lines).

Each of the reception modules 11-1 to 11-N can receive the optical signals input from the different directions. Then the reception modules 11-1 to 11-N are configured to cover the reception view of 360 degrees. Moreover, the reception modules 11-1 to 11-N wait for receiving the optical signal input from the other mobile units always. Further, the reception modules 11-1 to 11-N are configured also to be possible to perform a simultaneous multi channel reception.

Each of the transmission modules 12-1 to 12-M scans a direction of a transmission beam and “irradiates” an optical transmission signal to the opposite communication device. Then, it is possible to transmit the optical signal toward the direction of 360 degrees by a plural of the transmission modules 12-1 to 12-M. Moreover, each of the transmission modules 12-1 to 12-M performs a transmission by one channel basically.

Moreover, although an example of the transmission module and the reception module arranged side by side is described in FIG. 5, the arrangement is not limited as such. It is possible to arrange the transmission module and the reception module separately. Further, it is not required to coincide the number of the transmission modules with the reception modules always. That is, it is possible to arrange the arbitrary number of the transmission modules and the reception modules on the surface of the mobile unit independently.

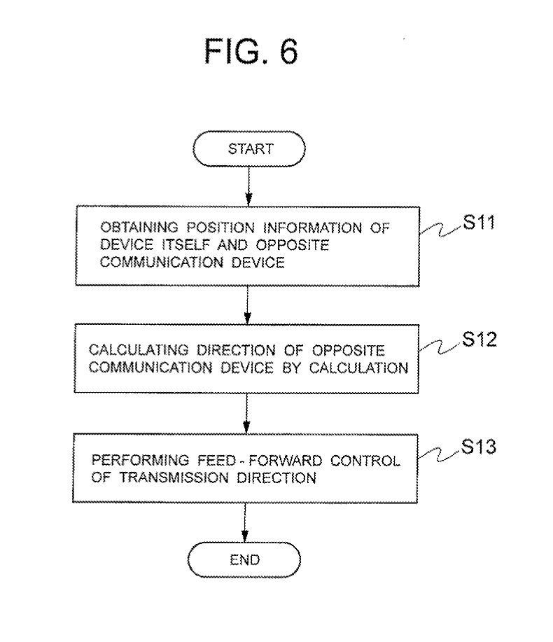

Next, an example of a capture and tracking method of the opposite communication device is described below. FIG. 6 is a flow chart showing an example of an operation of a capture and track method of an opposite communication device in an optical space communication device according to the present invention. As the capture and tracking method of the opposite communication device, that is, as a control method of a direction of a transmission optical signal in an optical space communication device, a programmable tracking method is applied.

That is, the method is, first, obtaining a position information (for example; obtaining an information of latitude, longitude and altitude, and so on) (step 11 of FIG. 6), second, calculating a direction of an opposite communication device by a prescribed calculation (step 12 of FIG. 6) and, third, performing a feed-forward control of a transmission direction (step 13 of FIG. 6).

By them, it can be easy to switch the opposite communication device because the capture and tracking of the opposite communication device can be achieved, even if no optical signal is input from the opposite communication device.

On the other hand, as applied to the related optical space communication generally, it is also possible to include a function of a feedback control of a transmission direction to a mobile unit by including a direction detection sensor to a reception module and detecting a direction of an opposite communication device in accordance with an optical signal input from the opposite communication device.

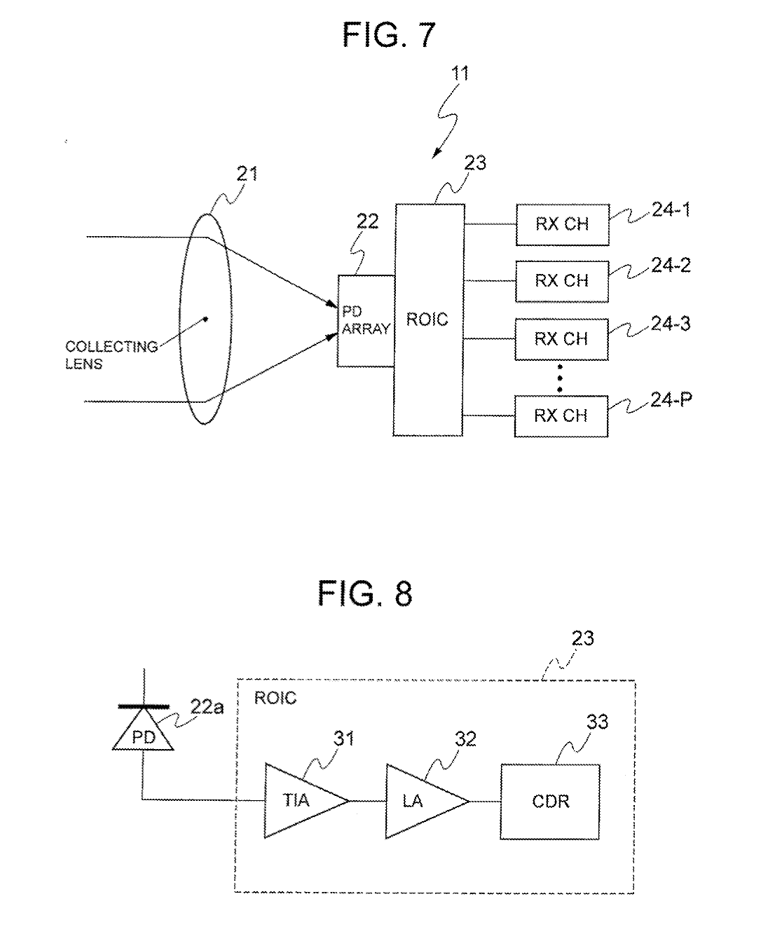

Next, an example of a configuration of the reception modules 11-1 to 11-N is described below. FIG. 7 is a diagram showing an example of a configuration of a reception module in an optical space communication device according to the present invention. Referring to FIG. 7, an example of the reception module 11 includes a collecting lens 21, a PD (Photo Diode) array 22, a readout unit (ROIC; Read Out Integrated Circuit) 23 and channel reception units (RX CH) 24-1 to 24-P (P is a integer equal to or more than 2).

That is, an optical signal collected by the collecting lens 21 is received by the PD array 22, data from the PD array 22 is read out by the readout unit 23, the data from the readout unit 23 is received by the channel reception units 24-1 to 24-P, and each data received by each channel reception unit is output per respective channel.

Next, a concrete example of a reception operation is described below. An optical signal is received by the wide collecting lens 21. The reception modules 11-1 to 11-N are waiting for reception always. It is assumed that a view angle of the collecting lens 21 is 100 degrees, for example. The PD array 22 receives optical signals transmitted from a plural of direction at the same time. The PD array 22 includes a plural of photo detector arranged length and width directions on the array, and it can distinguish the direction of the transmission optical signal (that is, the direction of the opposite communication device) in accordance with the position of each photo detector.

It is assumed that the PD array 22 is configured with 256×256 photo detectors, for example, an angle of view per a photo detector is 100 (degrees)/256=0.4 (degrees) approximately. Here, “100” indicates a light-receiving angle (degrees) of the collecting lens 21, and “256” indicates a number of the photo detector arranged length and width directions on the array of the PD array 22. That is, the PD array 22 can distinguish the optical signals not received by the light-receiving angle which is 0.4 (degrees) approximately from the received optical signals.

In other words, the optical signals not received by the light-receiving angle which is 0.4 (degrees) approximately can be received by an adjacent photo detector or another photo detector placed far from the adjacent photo detector. Therefore, the PD array 22 can receive the optical signals which are received by the light-receiving angle which is 0.4 (degrees) approximately and the other optical signals which are received by the light-receiving angle which is more than 0.4 (degrees) approximately at the same time.

On the other hand, for the 2 optical signals of which light-receiving angle is identical, it is possible to distinguish the opposite communication devices by adjusting the transmission time of the 2 optical signals on the transmission side to shift the transmission timing of them when the burst-like communication is performed.

It should be noted that 256×256 channels can be received at the same time in the exemplary embodiment of the present invention. However, in the event that the multi-channel reception is not required, it is possible, for example, to limit the number of receptions at a same time to 8 channels, and so on.

FIG. 8 is a diagram showing an example of a configuration of a readout unit (ROIC) 23 according to the present invention. Referring to FIG. 8, an example of a readout unit (ROIC) 23 includes a TIA (Trans Impedance Amplifier) 31, a LA (Limited Amplifier) 32 and a CDR (Check & Data Recovery) 33.

Then, an optical signal received by a photo detector (PD) 22a in the PD array 22 is converted to an electric signal by the photo detector (PD) 22a, and the electric signal is output through the TIA 31, the LA 32 and the CDR 33.

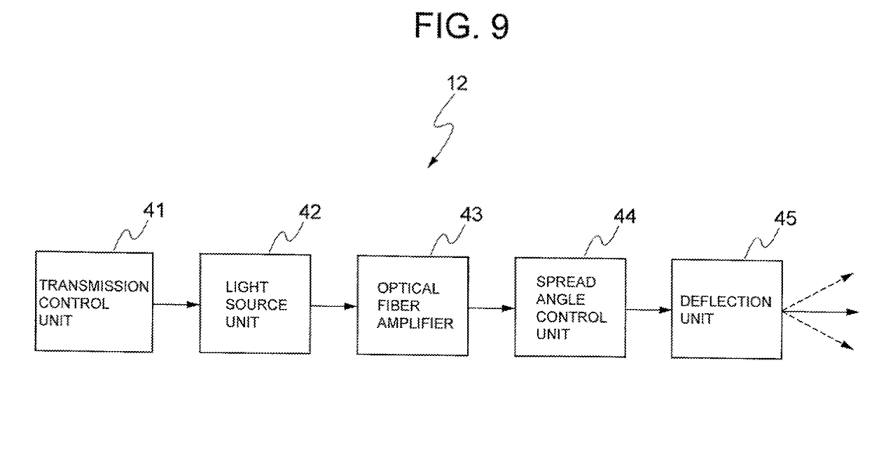

Next, an example of a configuration of the transmission module 12 is described below. FIG. 9 is a diagram showing an example of a configuration of a transmission module in an optical space communication device according to the present invention. Referring to FIG. 9, an example of the transmission module 12 includes a transmission control unit 41, a light source unit 42, an optical fiber amplifier 43, a spread angle control unit 44 and a deflection unit 45. The transmission module 12 amplifies an optical signal modulated at a high speed and outputs it.

The transmission control unit 41 outputs a transmission data. The light source unit 42 is formed, for example, with a semi-conductor laser (LD; Laser Diode). Then the light source unit 42 converts the transmission data input from the transmission control unit 41 to an optical signal and outputs it. It should be noted that it is possible to apply another laser except for the above-mentioned semi-conductor laser or an electricity to light conversion element as the light source unit 42. The optical fiber amplifier 43 amplifies an optical signal input from the light source unit 42.

The deflection unit 45 controls the spread angle of the beam of the optical signal input from the optical fiber amplifier 43. A deflection unit 44 controls the optical signal to transmit a beam of which spread angle is narrow to the opposite communication device located at a long distance, and to transmit a beam of which spread angle is wide to the opposite communication device located at a short distance.

That is, for the opposite communication device located at a long distance, since the beam spreads at the point of the opposite communication device where the beam arrives even if a transmission beam is narrow, it is possible to include the opposite communication device within the beam. In other words, it is easy to decide the direction of the opposite communication device. Moreover, since a spread angle of the beam is narrow, it is possible to strengthen, comparatively, the optical signal arrives at the point where the opposite communication device is.

On the other hand, for the opposite communication device located at a short distance, since a possibility that the direction of the beam goes out from the direction of the opposite communication device rises, the spread angle of the beam is set widen. By them, it becomes easy to correspond a transmission direction with the movement of the opposite communication device (that is, to the change of the direction of the opposite communication device). Although the strength of the optical signal arrives at the opposite communication device is weaken comparably if the spread angle of the beam is widen, a circuit margin is high comparably at a short distance. Then, it is possible to establish a circuit.

Therefore, it is possible to improve the stability of the capture and tracking for the opposite communication device by changing the spread angle of the transmission beam in accordance with the distance between the opposite communication device and the communication device of itself.

The deflection unit 45 controls the direction of the beam of the optical signal input from the spread angle control unit 44 and irradiates the optical signal to the opposite communication device.

It is possible to apply a mechanical device such as a galvano mirror, or an electronic device such as a light deflection crystal, and so on, as an example of the deflection unit 45.

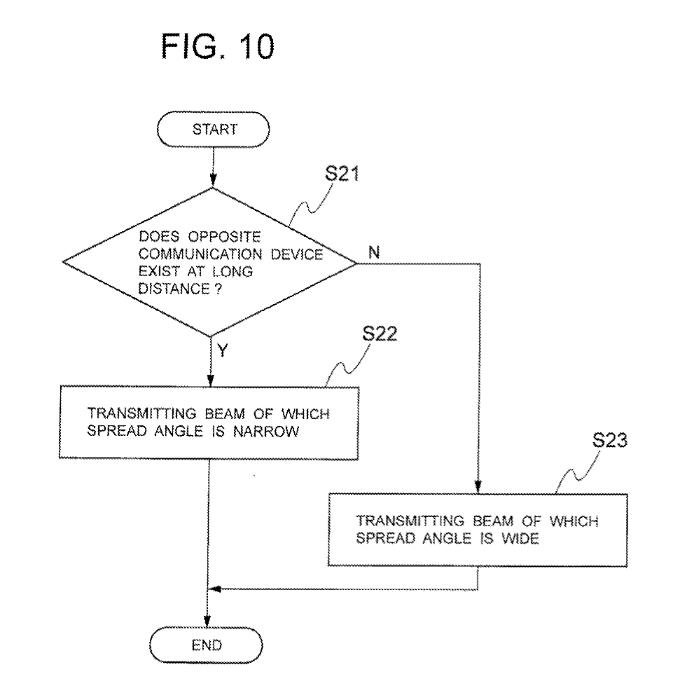

Next, an example of the operation of the spread angle control unit 44 is described below. FIG. 10 is a flow chart showing an example of an operation of a spread angle control unit 44 according to the present invention. Referring to FIG. 10, if the opposite communication device exists at a long distance (step S21, Y), the deflection unit 45 transmits a beam of which spread angle is narrow (step S22). On the other hand, if the opposite communication device exists at a short distance (step S21, N), the deflection unit 45 transmits a beam of which spread angle is wide (step S23).

As mentioned above, an exemplary advantage according to an exemplary embodiment of the optical space communication device, communication method thereof and optical space communication system of the present invention is that it is possible to transmit the optical signal to the specific opposite communication device without synchronizing with it, to receive the optical signal from a plurality of indefinite opposite communication devices at the same time of the transmission, to distinguish a plural of optical signal transmitted from the same direction each other on reception of the optical signal, and then to control the spread angle of the transmission beam in accordance with the distance of the opposite communication device.

Next, an example of a program of a communication method of an optical space communication system according to the present invention is described below.

As mentioned above, the optical space communication device of the present invention provides the program storing unit 14 (refer to FIG. 4). A program of a communication method of an optical space communication device which is shown as flow charts in FIGS. 3, 6 and 10 is stored in the program storing unit 14.

Referring to FIG. 4, the central communication control device 13 reads out the program of a communication method from the program storing unit 14, and controls the reception modules 11-1 to 11-N and the transmission modules 12-1 to 12-M in accordance with the program. It should be noted that since the control method of the central communication control device 13 has already been described in the specification, the descriptions of it is omitted here.

As mentioned above, an exemplary advantage according to an example of the program of the communication method of the optical space communication device according to the present invention is that it is possible to obtain a program transmitting the optical signal to the specific opposite communication device without synchronizing with it, receiving the optical signal from a plurality of indefinite opposite communication devices at the same time of the transmission, distinguishing a plural of optical signal transmitted from the same direction on reception of the optical signal, and then controlling the spread angle of the transmission beam in accordance with the distance of the opposite communication device.

The whole or part of the exemplary embodiments disclosed above can be described as, but not limited to, the following supplementary notes.
(Supplementary Note 1)

A recording medium recorded a program of a communication method of an optical space communication device, wherein the optical space communication device includes:

a transmission module transmitting an optical signal,

a reception module receiving the optical signal, and

a central communication control device controlling the transmission module and the reception module:

wherein the optical space communication device performs the program of;

instructing the transmission module perform a step of transmitting the optical signal to a specific opposite communication device whose position is known, and

instructing the reception module perform a step of receiving the optical signal transmitted from a plurality of indefinite opposite communication devices.
(Supplementary Note 2)

An optical space communication device, including:

a transmission means transmitting an optical signal to a specific opposite communication device whose position is known,

a reception means receiving the optical signal transmitted from a plurality of indefinite opposite communication devices, and

a central communication control means controlling the transmission module and the reception module.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An optical space communication device, comprising:
a transmission module transmitting an optical signal to a specific opposite communication device whose position is known,
a reception module receiving said optical signal transmitted from a plurality of indefinite opposite communication devices, and
a central communication control device controlling said transmission module and said reception module.

2. The optical space communication device according to claim 1, wherein said central communication control device calculates a direction of said opposite communication device in accordance with a position information of self device and said opposite communication device, and performs a feed-forward control of a transmission direction.

3. The optical space communication device according to claim 1, wherein a plural of said reception module are provided to receive said optical signal which conies from arbitrary direction.

4. The optical space communication device according to claim 1, wherein said optical signal transmitted from said transmission module comprises said position information of self device, and said central communication control device detects a position of said opposite communication device from said position information comprised in said optical signal of said opposite communication device received by said reception module.

5. A communication method of an optical space communication device, wherein said optical space communication device comprises:
a transmission module transmitting an optical signal,
a reception module receiving said optical signal, and
a central communication control device controlling said transmission module and said reception module:
wherein said central communication control device performs;
instructing said transmission module to transmit said optical signal to a specific opposite communication device whose position is known, and
instructing said reception module to receive said optical signal transmitted from a plurality of indefinite opposite communication devices.

6. The communication method according to claim 5, wherein said central communication control device calculates a direction of said opposite communication device in accordance with a position information of self device and said opposite communication device, and performs a feed-forward control of a transmission direction.

7. The communication method according to claim 5, wherein a plural of said reception module are provided to receive said optical signal which comes from arbitrary direction.

8. The communication method according to claim 5, wherein said optical signal transmitted from said transmission module comprises said position information of self device, and
said central communication control device detects a position of said opposite communication device from said position information comprised in said optical signal of said opposite communication device received by said reception module.

9. An optical space communication system, comprising:
a plural of said optical space communication device according to claim 1;
wherein a mesh type network is configured with each optical space communication device.

10. The optical space communication system according to claim 9, wherein said central communication control device calculates a direction of said opposite communication device in accordance with a position information of self device and said opposite communication device, and performs a feed-forward control of a transmission direction.

11. The optical space communication device according to claim 1, wherein a plural of said transmission module are provided to transmit said optical signal to arbitrary direction.

12. The optical space communication device according to claim 1, wherein said reception module comprising:
a collecting lens collecting said optical signal transmitted from a plural of directions at the same time,
a photo detector detecting said optical signal focused by said collecting lens with a prescribed angle,
a readout device separating and outputting said optical signal detected by said plural of a photo detector.

13. The optical space communication device according to claim 1, wherein said transmission module comprising:
a deflection unit controlling a beam direction of said optical signal for transmission,
a spread angle control unit controlling a spread angle of a beam of said optical signal for transmission.

14. The optical space communication device according to claim 1, wherein said spread angle control unit controls said optical signal to output a narrow spread angle beam toward an opposite communication device at a long distance and to output a wide spread angle beam toward an opposite communication device at a short distance.

15. The optical space communication device according to claim 1, wherein said optical space communication device is a mobile unit.

16. A communication method of an optical space communication device according to claim 5,
wherein said central communication control device instructs said transmission module to transmit said optical signal to a specific opposite communication device whose position is known, and instructs said reception module to receive said optical signal transmitted from a plurality of indefinite opposite communication devices, and
a plural of said transmission module are provided to transmit said optical signal to arbitrary direction.

17. A communication method of an optical space communication device according to claim 5, wherein said reception module comprising:
a collecting lens collecting said optical signal transmitted from a plural of directions at the same time,
a photo detector detecting said optical signal focused by said collecting lens with a prescribed angle,
a readout device separating and outputting said optical signal detected by said plural of a photo detector.

18. A communication method of an optical space communication device according to claim 5, wherein said transmission module comprising:
a deflection unit controlling a beam direction of said optical signal for transmission,
a spread angle control unit controlling a spread angle of a beam of said optical signal for transmission.

19. A communication method of an optical space communication device according to claim 5,
wherein said spread angle control unit controls said optical signal to output a narrow spread angle beam toward an opposite communication device at a long distance and to output a wide spread angle beam toward an opposite communication device at a short distance.

20. A communication method of an optical space communication device according to claim 5,
wherein said optical space communication device is a mobile unit.
